(19) United States
(12) Patent Application Publication
(10) Pub. No.: US 2010/0257294 A1
(43) Pub. Date: Oct. 7, 2010

(54) Configurable provisioning of computer system resources

(76) Inventors: Greg Regnier, Portland, OR (US); Sorin Iacobovici, San Jose, CA (US); Chetan Hiremath, Portland, OR (US); Udayan Mukherjee, Portland, OR (US); Nilesh Jain, Beaverton, OR (US)

Correspondence Address: INTEL CORPORATION;c/o CPA Global, P.O. BOX 52050, MINNEAPOLIS, MN, 55402, US

(21) Appl. No.: 12/384,568

(22) Filed: Apr. 6, 2009

(51) Int. Cl. G06F 13/42; G06F 15/167; G06F 13/00

(52) U.S. Cl. 710/105; 709/212; 710/300

(57) ABSTRACT

In some embodiments a system includes one or more processing nodes, a backplane, and one or more links to couple the one or more processing nodes to the backplane, wherein at least one of the one or more links is configurable as a standard Input/Output link and/or as a proprietary link. Other embodiments are described and claimed.

### TECHNICAL FIELD

The inventions generally relate to configurable provisioning of computer system resources.

### BACKGROUND

Blade-based servers typically include a set of self-contained compute blades. Each blade is connected through a backplane via a switch and a network technology such as, for example, Ethernet. Each blade has a limited scale-up capability due to the power, area and thermal constraints of the blade form-factor. Additionally, each blade must include a set of Input/Output devices (I/O devices) that it needs in order to access, for example, a Local Area Network (LAN), storage, and/or high-speed Inter-Process Communication (IPC) for clustering.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

FIG. 2 illustrates a system according to some embodiments of the inventions.

### DETAILED DESCRIPTION

Some embodiments of the inventions relate to configurable provisioning of computer system resources.

In some embodiments a system includes one or more processing nodes, a backplane, and one or more links to couple the one or more processing nodes to the backplane, wherein at least one of the one or more links is configurable to run a standard Input/Output protocol as well as a set of proprietary peer-to-peer protocols.

In some embodiments a processor includes one or more cores, one or more links to couple the processor to one or more other devices, and a bus interface unit to couple the one or more cores to the one or more links, and to configure one or more of the links as a standard Input/Output link and/or as a proprietary link.

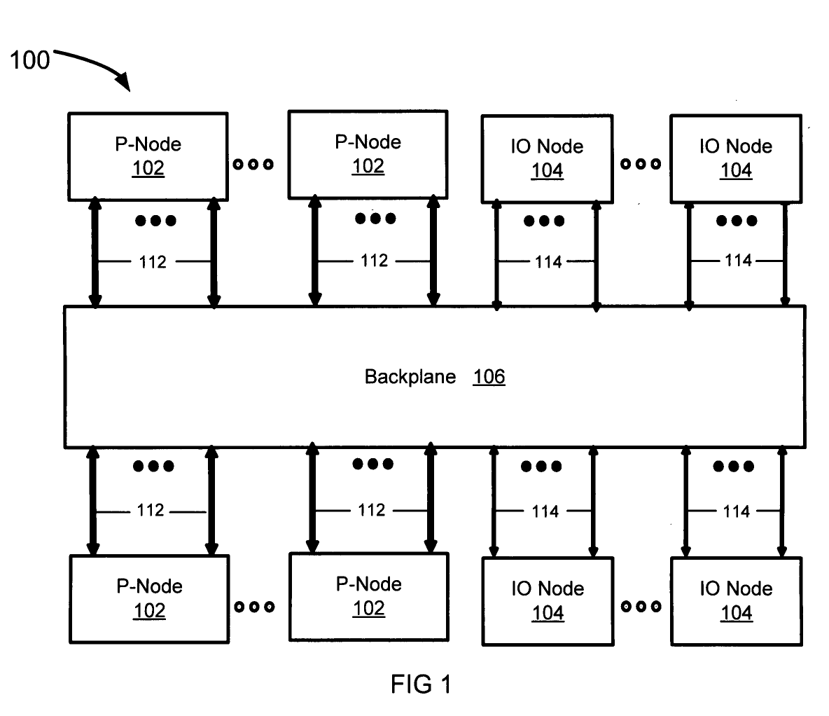

FIG. 1 illustrates a system 100 according to some embodiments. In some embodiments FIG. 1 illustrates a high-level view of one or more servers, one or more server chassis, one or more bladed servers, and/or one or more bladed server chassis. In some embodiments, system 100 includes two or more processing nodes (P-nodes) 102, two or more Input/Output nodes (IO nodes) 104, and one or more backplane 106. In some embodiments, backplane 106 is a passive backplane. The P-nodes 102 and the IO nodes 104 are coupled by the backplane 106. In some embodiments, a plurality of links 112 couple P-nodes 102 to backplane 106. In some embodiments, a plurality of links 114 couple IO nodes 104 to backplane 106. In some embodiments, one or more of the P-nodes is a processor, a multi-core processor, a central processing unit (CPU), a CPU chip, and/or a CPU package, etc.

In some embodiments, each node (for example, each P-node and/or each IO node) has a number of compliant links at the physical and data link layers. In some embodiments, each node (for example, each P-node and/or each IO node) has a number of links compliant with PCI Express (Peripheral Component Interconnect Express, or PCI-e) at the physical and data link layers. In some embodiments, each link 112 and/or link 114 can be configured as a compliant link (for example, a PCI-e link) or as another type of link (for example, a proprietary link running some set of proprietary protocols, to connect a P-node and/or an IO node to the backplane 106. In some embodiments, links 112 and/or links 114 are configurable by a Fabric Manager (not illustrated in FIG. 1) into one or more coherent domains, each domain being capable, for example, of running a standard OS (Operating System) or VMM (Virtual Machine Monitor) software. In this manner, coherent domains communicate over the switched interconnect fabric using a proprietary protocol (for example, a proprietary Inter-Process Communication (IPC) protocol) to create clusters. In some embodiments, links 112 can be configured as a compliant link (such as a PCI-e link) and/or as another type of link (such as a proprietary link), and links 114 are compliant links (such as a PCI-e link).

In some embodiments, a flexible and configurable system architecture may be used that includes multiple components. For example, in some embodiments, an interconnect network is implemented that is based on PCI Express standard Physical and Data Link layers. In some embodiments, a proprietary set of transaction layer protocols are implemented (for example, using Intel proprietary cache coherence protocols). These protocols could include, for example, a scalable coherent memory protocol, a low-overhead Remote Direct Memory Access-based (RDMA-based) Inter-Process Communication (IPC) protocol, a set of transactions for configuration and management, and/or separation of traffic types (for example, coherent, IPC, config, etc.) via Virtual Channels.

In some embodiments, a set of blocks (for example, hardware blocks) are integrated into one or more of the P-nodes and/or the IO nodes. For example, in some embodiments, hardware blocks are integrated into a CPU package, where the integrated hardware blocks include a coherent memory protocol engine (coherent memory PE), an Inter-Process Communication protocol engine (IPC PE), and/or a proprietary protocol switch.

In some embodiments, a system for configuration and management includes mechanisms to configure a given link as a standard link (for example, a standard PCI Express I/O link) and/or as a proprietary link. In some embodiments, a system for configuration and management includes mechanisms needed to create one or more coherent systems (for example, memory coherent systems) from a collection of nodes. In some embodiments, a system for configuration and management includes a set of software and/or firmware that includes a Node Manager, a Fabric Manager, and an interface to Original Equipment Manufacturer (OEM) Management Software. In some embodiments, the system for configuration and management includes one or more of these different mechanisms.

In some embodiments, systems provide a scalable memory coherence protocol. This enables the aggregation of computer and memory across, for example, blade boundaries. In some embodiments, the interconnect is configurable to enable the flexible creation of coherent memory domains across blade boundaries through a passive backplane. In some embodiments, a jungle fabric is based on the PCI Express standard such that some links may be configured as standard PCI Express (PCI-e) links to modularize the required Input/Output (I/O) resources. In some embodiments, the fabric supports a proprietary Inter-Process Communication (IPC) protocol that provides a built-in clustering facility without addition of a separate, high speed IPC network such as, for example, an Infiniband® network or a Myrinet® network.

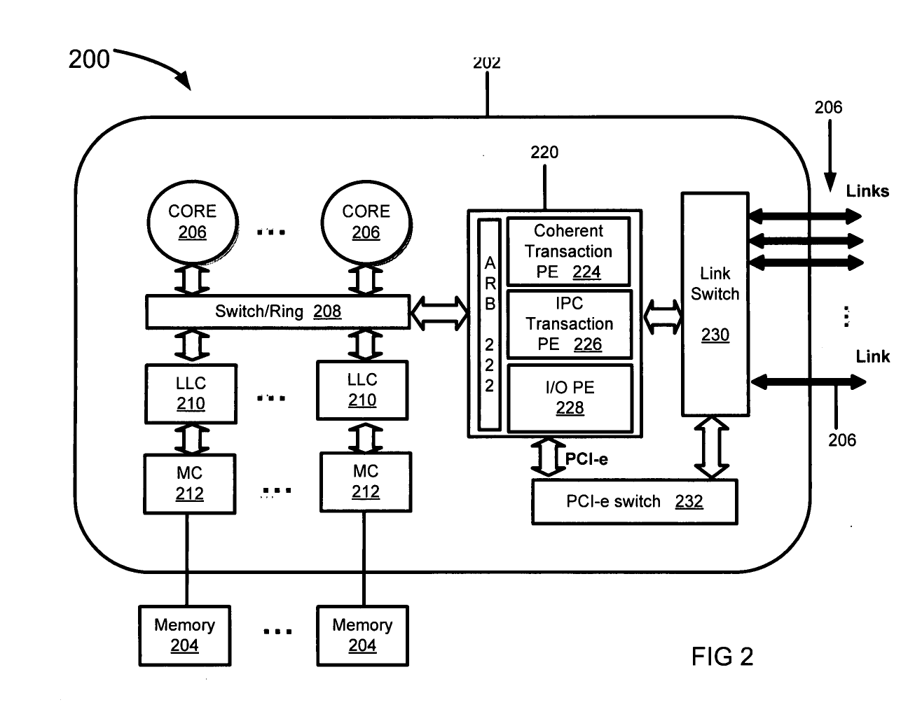

FIG. 2 illustrates a system 200 according to some embodiments. System 200 includes a processor 202 (for example, a microprocessor, a Central Processing Unit, a Central Processing Unit chip, a Central Processing Unit package, etc.), memory 204 (for example, one or more memories, one or more memory chips, and/or one or more memory modules), and one or more links 206. In some embodiments, processor 202 is the same as or similar to one or more of the P-nodes 102 and/or the same as or similar to one or more of the IO nodes 104. According to some embodiments, system 200 is a node that has a chip that integrates a multi-core processor, its caches and memory controllers, as well as the protocol engines and switches supporting the uniform, configurable interconnect. According to some embodiments, the node also has the memory needed by the processor chip.

Processor 202 includes one or more cores 206, a switch or ring 208, one or more Last Level Caches (LLCs) 210, and one or more memory controllers (MCs) 212. Additionally, a Bus Interface Unit (BIU) 220 is integrated into the processor 202 (for example, in the uncore of processor 202). Bus Interface Unit 220 includes an arbitrator 222, a Coherent Transaction Protocol Engine (PE) 224, an Inter-Process Communication (IPC) Protocol Engine (PE) 226, and an Input/Output (I/O) Protocol Engine (PE) 228. The Coherent Transaction PE 224 supports the generation of a scalable coherent protocol. The IPC PE 226 supports the generation of a proprietary Inter-Process Communication (IPC) protocol. The I/O PE 228 is a standard PCI-e Host Bridge and Root Complex (RC) for standard I/O connectivity across the backplane. Link switch 230 is a full cross-bar switch that connects PE 224, PE 226, and PE 228 to the output ports (for example, links 206), and enables the routing of Coherent and IPC traffic. An integrated PCI-e switch 232 enables the mapping of standard I/O to any of the output ports (for example, links 206) of the link switch 230. In some embodiments, links 206 couple the processor 202 to a backplane (for example, a passive backplane and/or backplane 106 of FIG. 1).

According to some embodiments, differentiation of a computing system such as a blade server system is obtained based on improved capabilities. For example, in some embodiments, it is possible to enable an aggregation of compute and memory capacity, to provide a built-in low-overhead IPC for clustering, and/or provide configurability for system resources including but not limited to computer, memory, and I/O capacity. Additionally, according to some embodiments, proprietary systems get benefits from the evolution of standard communications protocols such as PCI-e (for example, Speed, IOV, etc.) Additionally, in some embodiments, lower cost and/or lower power server blades may be implemented.

In some embodiments, multiple capabilities are combined to create a flexible and configurable system that provides system resources to applications where CPU, memory and I/O demand may vary over time.

Although embodiments have been described herein relating to blade systems, some embodiments apply to any modular system that may be connected by backplanes, mid-planes, cables, fiber optics or combinations thereof, for example. Therefore, the inventions are not limited to blade systems or being related to blade systems.

Although embodiments have been described herein as using a backplane that can in some embodiments be a passive backplane, in some embodiments, the backplane is a passive backplane, and/or is some combination of backplane, mid-plane, cables, and/or optical connections.

Although some embodiments have been described herein as being implemented according to some embodiments, according to some embodiments these particular implementations may not be required. For example, embodiments may be implemented with any number or type of processors, P-nodes, IO nodes, backplanes, and/or memory, etc.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A processor comprising:
one or more cores;
one or more links to couple the processor to one or more other devices; and
a bus interface unit to couple the one or more cores to the one or more links, and to configure one or more of the links as a standard Input/Output link and/or as a proprietary link.

2. The processor of claim 1, wherein the bus interface unit comprises:
a coherent transaction protocol engine to support a scalable coherent protocol; and
an Inter-Process Communication protocol engine to support a proprietary Inter-Process Communication protocol.

3. The processor of claim 2, wherein the scalable coherent protocol is a scalable coherent memory protocol.

4. The processor of claim 2, wherein the Inter-Process Communication protocol is a low-overhead Remote Direct Memory Access based Inter-Process Communication protocol.

5. The processor of claim 2, further comprising an Input/Output protocol engine to support standard Input/Output connectivity.

6. The processor of claim 2, further comprising a link switch to map the coherent transaction protocol engine and the Inter-Process Communication protocol engine to the links to enable routing of coherent and Inter-Process Communication traffic.

7. The processor of claim 5, further comprising a link switch to map the coherent transaction protocol engine, the Inter-Process Communication protocol engine, and the Input/Output protocol engine to the links to enable routing of coherent and Inter-Process Communication traffic.

8. The processor of claim 1, further comprising a link switch to map the bus interface unit to the links to enable routing of coherent and Inter-Process Communication traffic.

9. The processor of claim 1, further comprising a switch to enable mapping of standard Input/Output to the links.

10. The processor of claim 8, further comprising a switch to enable mapping of standard Input/Output to the links.

11. The processor of claim 1, wherein the processor is a node in a blade server.

12. The processor of claim 1, wherein the standard Input/Output link is a PCI Express link.

13. A system comprising:
one or more processing nodes; and
a backplane; and
one or more links to couple the one or more processing nodes to the backplane, wherein at least one of the one or more links is configurable as a standard Input/Output link and/or as a proprietary link.

14. The system of claim 13, wherein at least one of the one or more processing nodes includes:
a plurality of cores;
a plurality of the one or more links to couple the processing node to the backplane; and
a bus interface unit to couple the plurality of cores to the plurality of the one or more links, and to configure one or more of the plurality of the one or more links as a standard Input/Output link and/or as a proprietary link.

15. The system of claim 14, wherein the bus interface unit comprises:
a coherent transaction protocol engine to support a scalable coherent protocol; and
an Inter-Process Communications protocol engine to support a proprietary Inter-Process Communication protocol.

16. The system of claim 13, wherein the system is a blade server system.

17. The system of claim 13, wherein the standard Input/Output link is a PCI Express link.

18. The system of claim 13, further comprising a fabric manager to configure a plurality of the one or more links to form one or more coherent domains.

19. The system of claim 18, wherein the coherent domains are capable of running standard operating system or virtual machine monitor software.

20. The system of claim 18, wherein the coherent domains can communicate over the one or more links using an Inter-Process Communication protocol to create clusters.

21. The system of claim 13, wherein the backplane is a passive backplane, and/or is a combination of backplane, mid-plane, cables, and/or optical connections.
